(19) United States
(12) Patent Application Publication
(10) Pub. No.: US 2018/0135393 A1
(43) Pub. Date: May 17, 2018

(54) Methods For Microbially Enhanced Recovery of Hydrocarbons

(71) Applicant: UTI LIMITED PARTNERSHIP, Calgary (CA)

(72) Inventors: Gerrit Voordouw, Calgary (CA); Fatma Gassara, Calgary (CA); Akhil Agrawal, Bharatpur (IN)

(21) Appl. No.: 15/568,595

(22) PCT Filed: Apr. 22, 2016
(86) PCT No.: PCT/CA2016/050468

§ 371 Date: Oct. 23, 2017

Related U.S. Application Data
(60) Provisional application No. 62/173,459, filed on Jun. 10, 2015.

(30) Foreign Application Priority Data
Apr. 23, 2015 (IN) 1645/MUM/2015

(51) Int. Cl. E21B 43/24; E21B 43/26; C09K 8/592; C09K 8/582

(52) U.S. Cl. CPC E21B 43/2406; C09K 8/582; C09K 8/592; E21B 43/26

(57) ABSTRACT

Methods for the recovery of geological hydrocarbons from hydrocarbon reservoirs include injecting a low molecular weight oil soluble hydrocarbon compound and an electron acceptor into a reservoir, which enter a region of the reservoir comprising a microbial culture capable of metabolizing the low molecular weight hydrocarbon compound and the electron acceptor, thereby promoting flow of geological hydrocarbon.

### RELATED APPLICATIONS

This is a Patent Cooperation Treaty Application which claims benefit of 35 U.S.C. 119 based on the priority of corresponding Indian Patent Application No 1645/MUM/2015, filed on Apr. 23, 2015; and U.S. Provisional Patent Application No. 62/173,459, filed on Jun. 10, 2015, both of which are incorporated herein in their entirety.

### FIELD OF THE INVENTION

The disclosure described herein generally relates to methods for in situ recovery of hydrocarbons from geological formations, and more particularly to methods for microbially enhanced recovery of hydrocarbons from geological formations.

### BACKGROUND OF THE DISCLOSURE

The following paragraphs are provided by way of background to the present disclosure. They are not however an admission that anything discussed therein is prior art or part of the knowledge of persons of skill in the art

A considerable proportion of the world's petroleum reserves occur in the form of hydrocarbons within subterranean geological formations. Recovery of hydrocarbons from these geological formations traditionally progresses through three separate production phases. Primary oil recovery involves the implementation of a well and the use of the local underground pressure within the reservoir to force the oil to the surface. Upon dissipation of the underground pressure, secondary phase oil recovery is typically achieved by flooding the well with large amounts of water under pressure to force additional oil from the reservoir to the surface. Eventually this leads to breakthrough of injection water and to a decrease in the ratio of produced oil to water until secondary recovery no longer yields effective quantities of oil.

Tertiary oil recovery processes have been employed to produce residual oil in place (ROIP) following primary and secondary phases of oil recovery. These processes include Chemically Enhanced Oil Recovery (CEOR), which involve the injection of chemicals, such as surfactants, polymers, acids, gases or solvents into the reservoir. CEOR processes typically result in recovery of a portion of the residual oil, however CEOR methods are expensive, resulting in diminishing economic returns. Furthermore CEOR methods frequently involve the use of environmentally hazardous materials. Thus tertiary oil production is technically and economically challenging. However residual oil remains a significant resource, representing currently approximately 67% of the total amount of oil reserves, or 2-4 trillion barrels (Shibulal et al., 2014, The Scientific World Journal; Article ID 3091159).

It should be noted that geological reservoir formations naturally include holes and fractures within which hydrocarbon is held. Fractures within the geological formation may include macro-fractures, milli-fractures or micro-fractures. The geological formations are further typically characterized by heterogeneous porosity and permeability distributions. The efficiency with which hydrocarbon may be extracted from the surrounding geological formation depends to a significant degree on the porosity and permeability characteristics of the geological formation.

It should also be noted that following extraction efforts oil remains within the fractures or holes of the reservoir formation in part due to its high viscosity, which limits its mobility and prevents its effusion by the less viscous injected water. Production of oil is also limited by high interfacial tension between oil and water, which results in high capillary forces that retain the oil in the micro-fractures in the geological formation. Furthermore oil remains in reservoirs since water injected during secondary phase production will flow through the areas of the geological formation with the highest permeability, thus bypassing substantial quantities of oil located in areas with low permeability.

Microbially Enhanced Oil Recovery (ME OR) represents an alternative tertiary oil recovery technology. In the performance of MEOR processes microbial biomass, biopolymers, gases, acids, solvents, enzymes and/or surface-active compounds, as well as microbial activities, such as hydrocarbon degradation and fracture plugging, have been employed to improve the recovery of ROIP from reservoirs (Sen, 2008, Process in Energy and Combustion Science (34) 714-724; Brown, 2010, Current Opinion in Microbiology (13): 316-320). The practice of MEOR processes typically involves the injection of either indigenous or exogenous microorganisms to produce useful products by supplying an inexpensive raw material, such as molasses, as a substrate and in situ fermentation of the substrate. However the known raw materials or combinations of raw materials, and delivery methodologies remain suboptimal. Thus, for example, molasses is commonly used as a substrate to promote bacterial growth, but the high solubility in water of molasses creates challenges for the deposition of molasses in reservoirs, as a substantial portion of molasses is washed out with the injection water. Impaired deposition of molasses within the reservoir in turn limits the production of microbial biomass and restricts the fraction of residual oil that may be recovered using MEOR.

Thus there remain still significant shortcomings in the conventional methodologies for recovering hydrocarbons from oil reservoirs, limiting the total amounts of recoverable oil. There is a need for novel methodologies that safely allow further recovery of oil from geological formations. In particular, there is a need to enhance tertiary production processes.

### SUMMARY OF THE DISCLOSURE

The present disclosure provides novel methodologies for the recovery of hydrocarbons from geological formations. The methods provided herein are superior in many respects, in particular with respect to their efficacy in promoting flow of hydrocarbons from geological formations and improvement in the fraction of geological hydrocarbons that may be recovered from geological formations containing hydrocarbons.

Accordingly, the present disclosure provides, in at least one aspect, at least one implementation of a method of recovering geological hydrocarbon from a hydrocarbon reservoir, the method comprising:
(a) introducing a low molecular weight oil soluble hydrocarbon compound and an electron acceptor into a hydrocarbon reservoir wherein at least a portion of the low molecular weight oil soluble hydrocarbon compound and the electron acceptor enters a region of the hydrocarbon reservoir comprising geological hydrocarbon and a microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(b) recovering the geological hydrocarbon from the hydrocarbon reservoir.

In some implementations, a microbial stimulation fluid comprising a low molecular weight oil soluble hydrocarbon compound and an electron acceptor is injected into the hydrocarbon reservoir.

In some implementations, a microbial stimulation fluid is injected at an injection point in the hydrocarbon reservoir and a low molecular weight oil soluble hydrocarbon and an electron acceptor are deposited in a deposition zone in the reservoir, wherein the injection point is adjacent to the deposition zone.

In some implementations, a microbial stimulation fluid is injected at an injection point in the hydrocarbon reservoir and a low molecular weight oil soluble hydrocarbon and an electron acceptor are deposited in a deposition zone in the reservoir, wherein the injection point is spaced away from the deposition zone.

In some implementations, the region in the hydrocarbon reservoir in which the low molecular weight oil soluble hydrocarbon and electron acceptor are deposited is preheated to a temperature from about 30° C. to about 90° C.

In some implementations, a first microbial stimulation fluid comprising the low molecular weight oil soluble hydrocarbon compound is injected into the hydrocarbon reservoir, and a second microbial stimulation fluid comprising an electron acceptor is injected into the hydrocarbon reservoir.

In some implementations, the region in which the low molecular weight oil soluble hydrocarbon and electron acceptor are deposited are soaked prior to commencing hydrocarbon recovery.

In some implementations, a microbial stimulation fluid is co-injected in the reservoir with another fluid used to pressurize the reservoir.

In some implementations, the reservoir comprises heavy oil.

In some implementations, the microbial culture uses a reducible nitrogen containing compound as an electron acceptor.

In some implementations, the microbial culture uses nitrate as an electron acceptor and forms NO₂⁻; N₂O; NO; N₂ or NH₄⁺.

In some implementations, the microbial culture uses the oil soluble low molecular weight hydrocarbon as an electron donor and forms H₂O and CO₂.

In some implementations, the microbial culture comprises bacterial species belonging to the phylum Proteobacteria; Actinobacteria; Bacteroidetes; Euryarchaeota; or Firmicutes.

In some implementations, indigenous microbial cultures are identified in the reservoir.

In some implementations, an indigenous microbial culture capable of metabolizing a low molecular weight oil soluble hydrocarbon compound and an electron acceptor is identified in the reservoir.

In some implementations, the present disclosure provides a method comprising:
(a) identifying a microbial culture capable of metabolizing an oil soluble low molecular weight hydrocarbon and an electron acceptor in a hydrocarbon reservoir;
(b) introducing a low molecular weight oil soluble hydrocarbon compound and the electron acceptor into the hydrocarbon reservoir wherein at least a portion of the low molecular weight oil soluble hydrocarbon compound and the electron acceptor enters a region of the hydrocarbon reservoir comprising geological hydrocarbon and the microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(c) recovering the geological hydrocarbon from the hydrocarbon reservoir.

In some implementations, the low molecular weight oil soluble hydrocarbon is an aliphatic hydrocarbon or an aromatic hydrocarbon.

In some implementations, the low molecular weight oil soluble hydrocarbon is dissolved in the microbial stimulation fluid to a concentration of approximately its solubility limit.

In some implementations, the low molecular weight oil soluble hydrocarbon is toluene or heptane or a mixture thereof.

Other features and advantages of the present disclosure will become apparent from the following detailed description. It should be understood, however, that the detailed description and the specific examples, while indicating preferred embodiments of the disclosure, are given by way of illustration only, since various changes and modifications within the spirit and scope of the disclosure will become apparent to those of skill in the art from the detailed description.

### BRIEF DESCRIPTION OF THE FIGS.

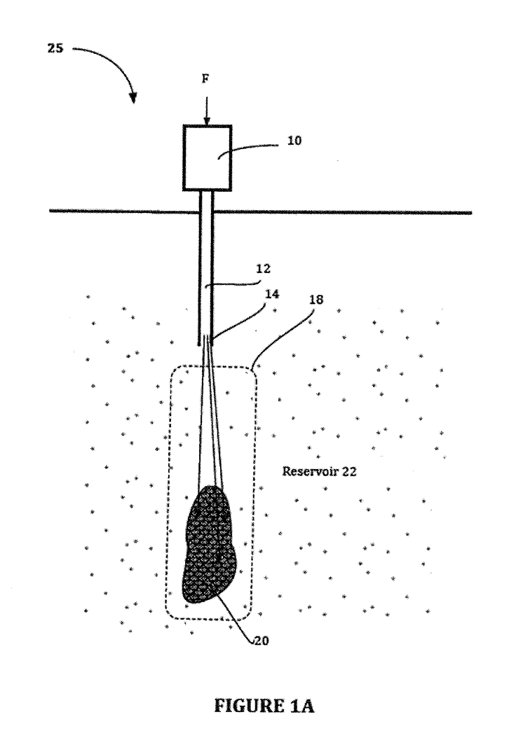

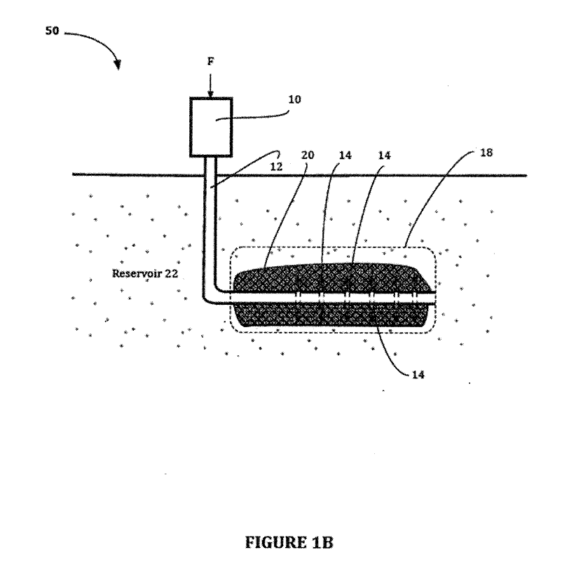

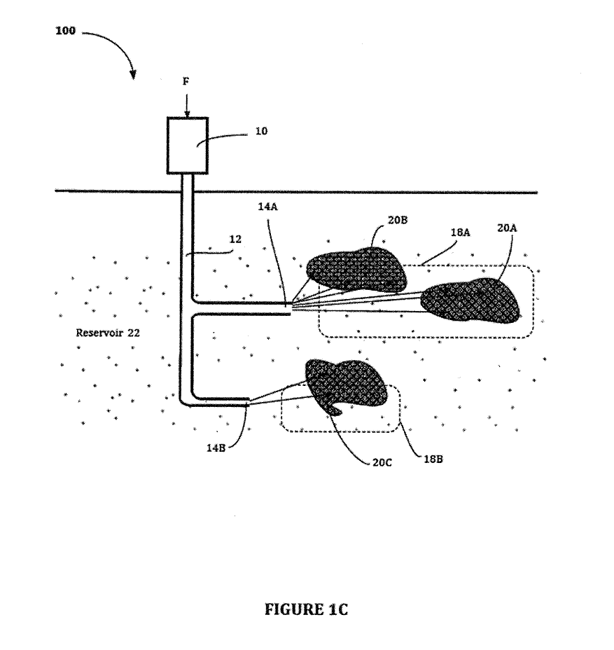

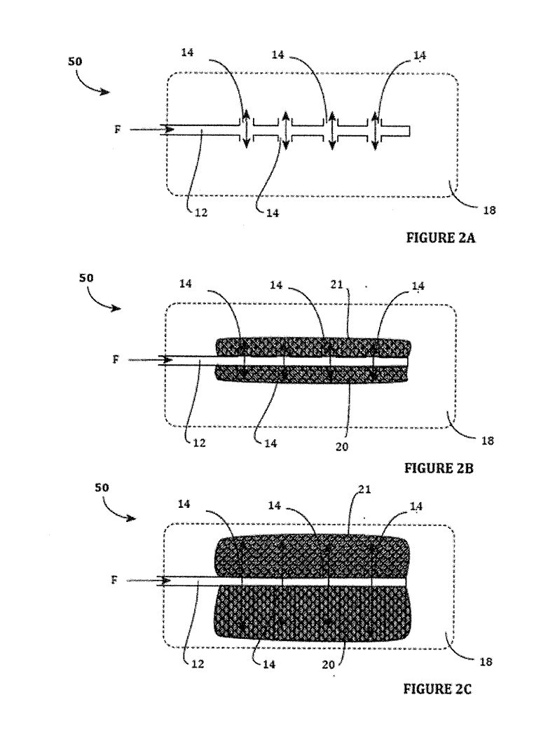

The disclosure is in the hereinafter provided paragraphs described, by way of example, in relation to the attached figures. The figures provided herein are provided for a better understanding of the example embodiments and to show more clearly how the various implementations may be carried into effect. The figures are not intended to limit the present disclosure. It is further noted that identical numbering of elements in different figures is intended to refer the same element, possibly shown situated differently or from a different angle. Thus, by way of example only, element (12) refers to a tubing string in FIG. 1A; FIG. 1B; FIG. 1C; FIG. 2A; and FIG. 2B.

FIG. 1A; FIG. 1B and FIG. 1C depict schematic side-views of a well in accordance with three different implementations

FIG. 2A and FIG. 2B depict schematic side-views of the expansion of a deposition zone in a reservoir in accordance with an implementation hereof.

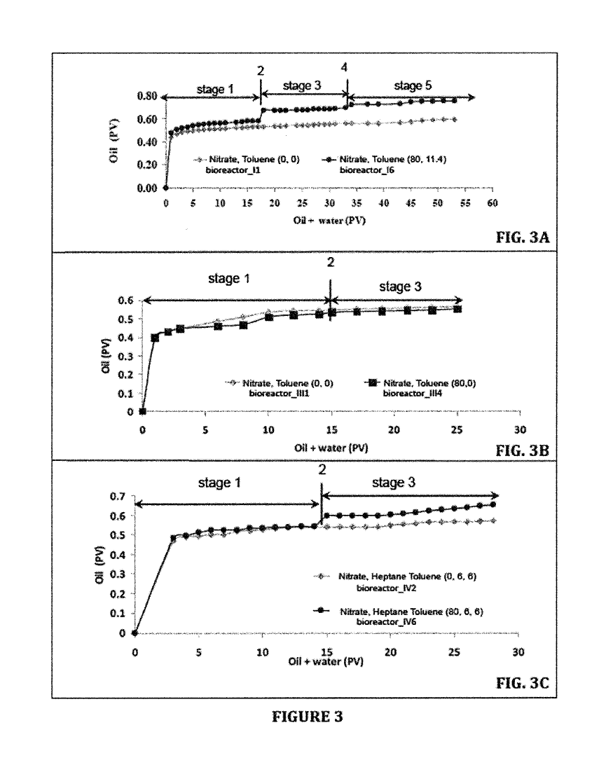

FIG. 3 (FIG. 3A; FIG. 3B; and FIG. 3C) depict a set of graphs representing certain results obtained in the experimentation detailed in Example 1, and showing the flow of oil in a low pressure reservoir model system when injected with low molecular weight hydrocarbons (toluene; heptane) and an electron acceptor (nitrate) and controls.

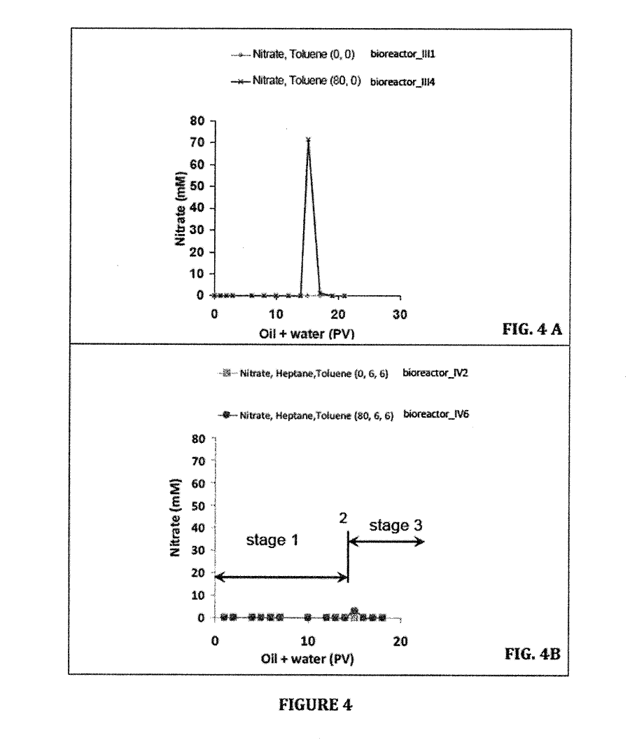

FIG. 4 (FIG. 4A and FIG. 4B) depict a set of graphs representing certain results obtaining in the experimentation detailed in Example 1, and showing nitrate metabolism in a low pressure reservoir model system when injected with low molecular weight hydrocarbons (toluene; heptane) and an electron acceptor (nitrate) and controls and controls.

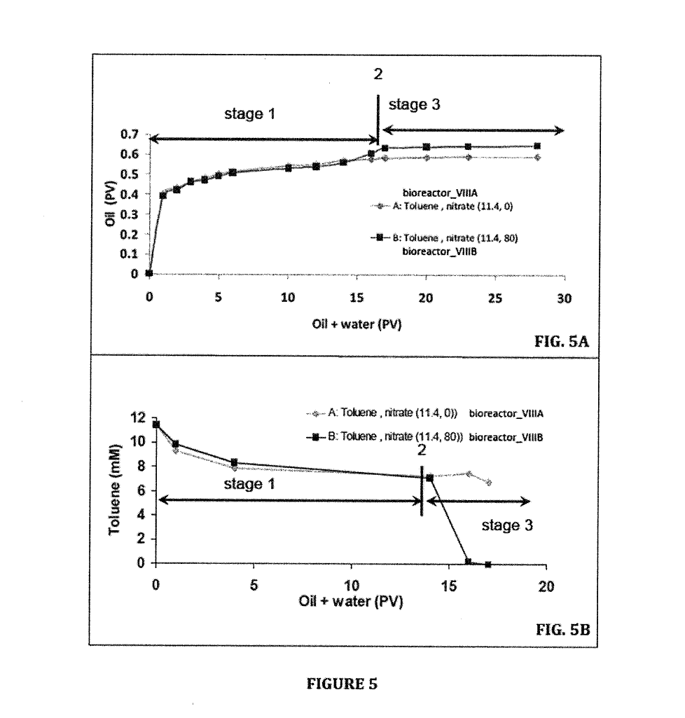

FIG. 5 (FIG. 5A and FIG. 5B) depicts a set of graphs representing certain results obtaining in the experimentation detailed in Example 2, and showing the flow of oil in a high pressure reservoir model system when injected with low molecular weight hydrocarbons (toluene) and an electron acceptor (nitrate) and controls.

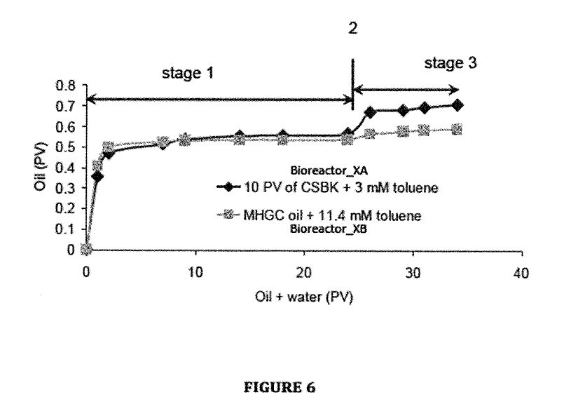

FIG. 6 depicts a graph representing certain results obtaining in the experimentation detailed in Example 4, and showing the flow of oil in a reservoir model system when injected with low molecular weight hydrocarbons (toluene) and an electron acceptor (nitrate) and control comprising oil spiked with low molecular weight carbon.

### DETAILED DESCRIPTION OF THE DISCLOSURE

Various methods, processes, systems and assemblies will be described below to provide an example of an implementation of each claimed subject matter. No implementations or embodiments described below limits any claimed subject matter and any claimed subject matter may cover methods, processes, systems or assemblies that differ from those described below. The claimed subject matter is not limited to methods having all of the features of any one method, process, system, or assembly described below or to features common to multiple or all of the methods, processes, systems or assemblies described below. It is possible that a method described below is not an embodiment of any claimed subject matter. Any subject matter disclosed in a method, process, assembly or system described below that is not claimed in this document may be the subject matter of another protective instrument, for example, a continuing patent application, and the applicants, inventors or owners do not intend to abandon, disclaim or dedicate to the public any such subject matter by its disclosure in this document.

It should be noted that terms of degree such as “substantially”, “about” and “approximately” as used herein mean a reasonable amount of deviation of the modified term such that the end result is not significantly changed. These terms of degree should be construed as including a deviation of the modified term if this deviation would not negate the meaning of the term it modifies.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

All publications, patents and patent applications are herein incorporated by reference in their entirety to the same extent as if each individual publication, patent or patent application was specifically and individually indicated to be incorporated by reference in its entirety.

As hereinbefore mentioned, the present disclosure relates to novel methodologies for recovering hydrocarbons. Accordingly, the present disclosure provides methods for introduction of chemical compounds in hydrocarbon reservoirs, and, unexpectedly, promoting the effusion of hydrocarbon from such reservoirs, thereby permitting recovery of hydrocarbon. The methods provided herein are beneficial in that they allow for a significant and surprising improvement in the fraction of hydrocarbon that may be recovered from hydrocarbon reservoirs. The methods provided herein comprise the use of low molecular weight hydrocarbon compounds and an electron acceptor, which heretofore, to the best knowledge of the inventors, have not been used together as agents to promote recovery of geological hydrocarbon from hydrocarbon reservoirs. The practice of the techniques of the present disclosure permits recovery of residual hydrocarbon present in reservoirs, which, using heretofore known technologies, may not be recoverable in an economic manner. It is an advantage of the methodologies of the present disclosure that they permit continued flow of water or other well pressure fluids used for secondary oil production. Thus the here provided techniques do not require interruption of oil production from a reservoir, or soaking time. It is a further advantage of the here disclosed methods, that low molecular hydrocarbon compounds and electron acceptor of the present disclosure are inexpensive and readily available agents and there exists an established and safe global operational infrastructure for the manufacturing, transport and handling of these agents.

Accordingly, the present disclosure provides, in at least one aspect, at least one implementation of a method of recovering geological hydrocarbon from a hydrocarbon reservoir, the method comprising:
(a) introducing a low molecular weight oil soluble hydrocarbon compound and an electron acceptor into a hydrocarbon reservoir wherein at least a portion of the low molecular weight oil soluble hydrocarbon compound and the electron acceptor enters a region of the hydrocarbon reservoir comprising geological hydrocarbon and a microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(b) recovering the geological hydrocarbon from the hydrocarbon reservoir.

### Terms and Definitions

The term “hydrocarbon” as used herein refers to any compound consisting of hydrogen and carbon and includes, without limitation, any saturated hydrocarbons (linear or cyclic alkanes) including without limitation, methane, ethane, propane, butane, pentane, hexane, heptane, octane, nonane, and decane and other linear saturated hydrocarbons of the general formula CₙH₂ₙ₊₂, any unsaturated hydrocarbons (linear or cyclic alkenes or alkynes) and any aromatic or polyaromatic hydrocarbons as well as polymers or mixtures of any of the foregoing. The term “hydrocarbon” as used herein further also includes any compound consisting primarily of carbon and hydrogen but additionally bearing heteroatoms, including but not limited to, oxygen, nitrogen, sulfur or metal atoms. Examples of such heteroatom bearing hydrocarbons include, but are not limited to, naphthenic acids and thiophenes. The hydrocarbons used herein can be liquids, hexane or benzene for example, low melting solids, paraffin waxes for example, or solids, high molecular weight resins or asphaltenes for example, or any other hydrocarbons natively present in geological rock formations. Hydrocarbons used herein include, oil, including, without limitation, any crude oil, heavy crude oil, and light crude oil, petroleum, shale oil, shale gas, and bitumen.

The term “low molecular weight hydrocarbon compound” refers to a hydrocarbon compound comprising no more than 20 carbon atoms, including aliphatic and aromatic low molecular weight hydrocarbon compounds. Examples of low molecular weight hydrocarbon compounds include toluene and heptane.

The term “geological hydrocarbon” refers to hydrocarbon in situ associated with a geological structure.

The term “hydrocarbon reservoir” refers to a geological formation comprising hydrocarbon. The geological hydrocarbon may be more or less evenly distributed throughout the reservoir. Thus certain regions of the reservoir may comprise little or no hydrocarbon while other regions may comprise substantial quantities of hydrocarbon. The geological formation may be a subterranean geological formation. “Subterranean”, as used herein refers to geological topographies below the surface of the earth. Such topographies may be located at least 10 meters below the surface of the earth, more typically at least 100 meters below the surface of the earth. The hydrocarbon reservoirs may also be located at considerable depth, for example, 1, 5 or 10 kilometers below the surface of the earth or even deeper. The hydrocarbon reservoirs may further be located beneath land or beneath a seabed or ocean floor.

The term “electron acceptor” as used herein refers to a chemical compound capable of accepting electrons to it when transferred from another chemical compound. Upon accepting an electron, the electron acceptor is chemically reduced.

### General Implementation

In accordance with the present disclosure, chemical compounds are introduced in a hydrocarbon reservoir to achieve promotion of metabolic activity of microbial communities present in the hydrocarbon reservoir. In one implementation, an exogenous low molecular weight oil soluble hydrocarbon compound and an exogenous electron acceptor are introduced into a hydrocarbon reservoir. Various techniques are described herein to achieve promotion of the metabolic activity of microbial communities to enhance a subsequent geological hydrocarbon recovery operation. The low molecular weight hydrocarbon compound and electron acceptor are introduced into the reservoir in such a manner that at least part of the low molecular weight hydrocarbon compound and the electron acceptor can enter a region of a the reservoir that comprises a microbial culture capable of metabolizing the low molecular weight hydrocarbon compound and electron acceptor. In some implementations, a microbial stimulation fluid including a low molecular weight hydrocarbon compound and an electron acceptor is prepared and injected in the reservoir. The injection point of the microbial stimulation fluid may be located in a remote zone and may be separate from the region to be treated, as the low molecular weight hydrocarbon compound and electron acceptor may diffuse into the region.

The techniques herein described involve the use of a low molecular weight hydrocarbon compound and introduction thereof in a reservoir. A wide variety of low molecular weight hydrocarbon compounds may be selected. In accordance herewith the selected low molecular weight hydrocarbon compound is oil soluble, notably in reference to the geological hydrocarbon to be recovered from the reservoir. In some implementations, the low molecular weight hydrocarbon compound is additionally soluble in water. In preferred implementations, the solubility of the low molecular weight hydrocarbon compound in oil is higher than the solubility of the low molecular weight hydrocarbon compound in water. Thus in some implementations, the solubility of the low molecular weight hydrocarbon compound is at least 5× the solubility of the low molecular weight hydrocarbon compound in water. In other implementations, the solubility of the low molecular weight hydrocarbon compound in oil is at least 10×; at least 100×; at least 1,000×; at least 10,000×, or at least 100,000× the solubility of the low molecular weight hydrocarbon compound in water. In some implementations, the solubility of the low molecular weight hydrocarbon compound in oil is higher than the solubility of the low molecular weight hydrocarbon compound in a microbial stimulation fluid. Thus in some implementations, the solubility of the low molecular weight hydrocarbon compound is at least 5× the solubility of the low molecular weight hydrocarbon compound in a microbial stimulation fluid. In other implementations, the solubility of the low molecular weight hydrocarbon compound in oil is at least 10×; at least 100×; at least 100×; at least 1,000×; at least 10,000×, or at least 100,000× the solubility of the low molecular weight hydrocarbon compound in a microbial stimulation fluid. In some implementations, the oil solubility of the low molecular weight hydrocarbon compound is at least 100,000 ppm; at least 10,000 ppm; at least 1,000 ppm; at least 100 ppm; at least 10 ppm; or at least 1 ppm in water or in a microbial stimulation fluid. The oil soluble low molecular weight hydrocarbon compound is provided in such a manner that it represents the primary fermentable carbon source provided and available to the microbial culture. In some implementations, the oil soluble low molecular weight hydrocarbon is provided in such a manner that it includes no more than 50% (w/w) carbon containing compounds having a higher solubility in water than in oil. In some implementations, the oil soluble low molecular weight hydrocarbons include no more than 40% (w/w) of carbon containing compounds having a higher solubility in water than in oil; no more than 30% (w/w) of carbon containing compounds having a higher solubility in water than in oil; no more than 20% (w/w) of carbon containing compounds having a higher solubility in water than in oil; no more than 10% (w/w) of carbon containing compounds having a higher solubility in water than in oil; or no more than 5% (w/w) of carbon containing compounds having a higher solubility in oil than in water. In some implementations, the oil soluble low molecular weight hydrocarbon compound is provided in such a manner that carbohydrate compounds, whether monomeric or polymeric, represent no more than 50% of the fermentable carbon source provided and available to the microbial culture, e.g. about 40% (w/w) or less; about 30% (w/w) or less; about 20% (w/w) or less; about 15% (w/w) or less; about 10% (w/w) or less; about 5% (w/w) or less; about 3% w/w or less; about 2% (w/w) or less; or at least about 1% or less.

The concentration, amount and form of the low molecular weight hydrocarbon compound that is selected may vary. In some implementations, the concentration of low molecular weight hydrocarbon is selected to be at a concentration of approximately the solubility limit of the low molecular weight hydrocarbon compound in water. In other implementations, the concentration of the low molecular weight hydrocarbon is selected to be up to about 0.9×; about 0.8×; about 0.7×; about 0.6×; about 0.5×; about 0.4×; about 0.3×; about 0.2×; or about 0.1× the solubility limit of the low molecular weight hydrocarbon in water. In some implementations, the concentration of low molecular weight hydrocarbon is selected to be approximately the solubility limit of the low molecular weight hydrocarbon compound in a microbial stimulation fluid. In other implementations, the concentration of the low molecular weight hydrocarbon is selected to be up to about 0.9×; about 0.8×; about 0.7×; about 0.6×; about 0.5×; about 0.4×; about 0.3×; about 0.2×; or about 0.1× the solubility limit of the low molecular weight hydrocarbon in a microbial stimulation fluid. Further the concentration of low molecular weight hydrocarbon compound is selected to be sufficient to be metabolized, i.e. to serve as an electron donor, by an in situ microbial reaction. In implementations hereof where amounts of low molecular weight hydrocarbon compounds are present in situ in the reservoir, the concentration of the low molecular weight hydrocarbon compound may be selected in such a manner that upon injection of the low molecular weight hydrocarbon compound, a substantial increase in the concentration of the low molecular weight hydrocarbon compound in situ is achieved, e.g. a 2× increase; a 5× increase; a 10× increase; a 100× or more increase. The concentration of a low molecular weight hydrocarbon compound may be adjusted or optimized, for example by preparing a plurality of samples, each containing a different concentration of a low molecular weight hydrocarbon compound; injecting each sample into a hydrocarbon reservoir, or a core sample thereof; and measuring the metabolic activity, e.g. the conversion of the low molecular weight hydrocarbon compound or nitrate reduction. Then a concentration of low molecular weight hydrocarbon compound may be selected that provides enhanced metabolic activity and/or degradation of the low molecular weight hydrocarbon compound. Other operating parameters, such e.g. as temperature or delivery pressure, may similarly be adjusted and optimized. There may be variation in optimal conditions, including the concentration of low molecular weight hydrocarbon compound, depending on a variety of conditions including the reservoir that is selected.

In some implementations, the fraction of low molecular weight hydrocarbon compounds having no more than 5 carbon atoms; no more than 6 carbon atoms; no more than 7 carbon atoms; no more than 8 carbon atoms; no more than 9 carbon atoms; no more than 10 carbon atoms; no more than 11 carbon atoms; no more than 12 carbon atoms; no more than 13 carbon atoms; no more than 14 carbon atoms; no more than 15 carbon atoms; no more than 16 carbon atoms; no more than 17 carbon atoms; no more than 18 carbon atoms; or no more than 19 carbon atoms comprises at least 90% (w/w), at least 95% (w/w), at least 96% (w/w), at least 97% (w/w), at least 98% (w/w) or at least 99% (w/w/) of the total amount of low molecular weight hydrocarbon compounds.

In some implementations, the low molecular weight hydrocarbon compound that is used is an aliphatic low molecular weight hydrocarbon compound, including a low molecular weight alkane, including pentane (C5H12), hexane (C₆H₁₄), octane (C₈H₁₈), nonane (C₉H₂₀), decane (C₁₀H₂₂) or a mixture of one of the foregoing.

In some implementations, the low molecular weight hydrocarbon compound that is used is an aromatic low molecular weight hydrocarbon compound.

In some implementations, the low molecular weight hydrocarbon is a mixture of an aromatic and aliphatic hydrocarbon.

In some implementations, the oil soluble low molecular weight hydrocarbon compound that is used is toluene. In some implementations, the concentration of toluene is selected such that upon preparation of a microbial stimulation fluid the final concentration of toluene in the microbial stimulation fluid is about 5 mM or less, e.g. about 4 mM; about 3mM; about 2.5 mM; about 2 mM; about 1 mM; about 0.5 mM or less.

In some implementations, the oil soluble low molecular weight hydrocarbon compound that is used is heptane.

In some implementations, the oil soluble low molecular weight hydrocarbon compound that is used is a mixture of toluene and heptane.

In some implementations, the low molecular weight hydrocarbon is a substantially pure compound free of other low molecular weight hydrocarbons. In other implementations, the low molecular weight hydrocarbon is a mixture, for example, a mixture of commercially available or synthetically blended low molecular weight hydrocarbons, such as gasoline, BTEX (benzene, toluene, ethylbenzene and xylene), BTEXS (benzene, toluene, ethylbenzene, xylenes and styrene), BTEXN (benzene, toluene, ethylbenzene, xylenes and naphthalene), naphta and C5+, a mixture of hydrocarbons comprising 5 or more hydrocarbons.

The techniques herein described further involve the use and introduction of an electron acceptor into a reservoir. The electron acceptor may be any electron acceptor having sufficient reduction potential to be reduced in conjunction with the metabolism of a low molecular weight hydrocarbon by a hydrocarbon reservoir microbial culture.

In some implementations, the electron acceptor is a reducible nitrogen containing compound, including, for example, nitrate (NO₃⁻); nitrite (NO₂⁻); nitric oxide (NO); or nitrous oxide (N₂O). 1000621 In some implementations, nitrate is used an electron acceptor. Nitrate (NO₃⁻) may be provided in any suitable form, for example in the form of a nitrate salt. Thus in some implementations, nitrate is provided as sodium nitrate (NaNO₃); potassium nitrate (KNO₃), ammonium nitrate (NH₄NO₃), calcium nitrate Ca(NO₃)₂ or lithium nitrate (LiNO₃), or mixtures thereof.

The concentration, amount and form of nitrate that is used may vary. Nitrate may be dissolved in water or in a microbial stimulation fluid. Nitrate may directly be dissolved in crystalline form in water or in a microbial stimulation fluid, or a concentrated nitrate stock solution may be prepared and mixed with water or a microbial stimulation fluid. Final concentrations of nitrate in water or in a microbial stimulation fluid that may be used are e.g. 1 mM or more; 10 mM or more; 100 mM or more; or 1,000 mM or more. The concentration of nitrate may be adjusted or optimized, for example by preparing a plurality of samples, each containing a different concentration of nitrate; injecting each sample into a hydrocarbon reservoir, or a core sample thereof; and measuring the metabolic activity, e.g. the formation of nitrogen gas (N₂). Then a concentration of nitrate may be selected that provides enhanced metabolic activity and/or production of nitrogen.

Still other electron acceptors that may be used in accordance herewith include perchlorate (ClO₄⁻; chlorate (ClO₃⁻; chlorite (ClO₂⁻; hypochlorite (ClO⁻); ferric iron (Fe³⁺ or iron (III) (in soluble or chelated form); or oxygen (O₂) in gaseous, dissolved or chelated form.

The concentration and form wherein the electron acceptor is used may vary. The concentration of electron acceptor may be adjusted or optimized, for example by preparing a plurality of samples, each containing a different concentration of an electron acceptor; injecting each sample into a hydrocarbon reservoir, or a core sample thereof; and measuring the metabolic activity, e.g. the decrease of the concentration of the electron acceptor and/or the formation of the reduced form of the electron acceptor. Then a concentration of the electron acceptor may be selected that provides enhanced metabolic activity and/or production of the reduced electron acceptor.

The techniques herein disclosed involve the introduction of an oil soluble low molecular weight hydrocarbon compound and an electron acceptor into a hydrocarbon reservoir. The low molecular weight hydrocarbon compound and electron acceptor may be introduced and delivered in a reservoir in any manner that permits these compounds to reach a region comprising geological hydrocarbon and a microbial culture capable of metabolizing the low molecular weight hydrocarbon and the electron acceptor. Thus the chemical compounds may, for example, be introduced in the reservoir via a well bore. In some implementations, a microbial stimulation fluid comprising a low molecular weight hydrocarbon compound and electron acceptor may be prepared and may be injected into a hydrocarbon reservoir. The microbial stimulation fluid, in one implementation, may be prepared by contacting a quantity of a low molecular weight hydrocarbon compound and/or electron acceptor with a fluid, and mixing and dissolving the low molecular weight hydrocarbon compound and electron acceptor in the fluid to obtain a microbial stimulation fluid. The fluid may be any fluid capable of penetrating a hydrocarbon reservoir including, an aqueous liquid, water, a drilling fluid, a fracturing fluid or diluent. A microbial stimulation fluid further may be prepared to optionally include additional agents. These include for example emulsifiers, gelling agents, corrosion inhibitors, solvents, biocides limiting microbial growth of microbial mass at the well bore region and tubing, and the like. Further agents that may be included in a microbial stimulation fluid are microbial nutrients, for example ammonium an/or phosphate and/or sulfate and micronutrients, for example, copper, iron, manganese, magnesium, nickel, zinc, tungsten or selenate. These agents may be selected to be compatible with growth of microbial cultures. Furthermore, an exogenous microbial culture may be included in a microbial stimulation fluid. Such exogenous microbial culture includes a culture capable of metabolizing a low molecular weight hydrocarbon and an electron acceptor. Additional agents may be introduced into a reservoir as part of an injected microbial stimulation fluid, or they may be introduced separately.

The techniques herein disclosed involve the introduction of a low molecular weight hydrocarbon compound and an electron acceptor into a hydrocarbon reservoir. The hydrocarbon reservoir that is identified and selected may be any hydrocarbon reservoir comprising a region comprising a microbial culture capable of metabolizing a low molecular weight hydrocarbon compound and an electron acceptor. In accordance herewith, in some implementations, the hydrocarbon reservoir is a hydrocarbon reservoir comprising heavy hydrocarbons. In such implementations, “heavy hydrocarbons” in the reservoir should be understood to be hydrocarbons having a high viscosity at initial reservoir conditions and an American Petroleum Institute (API) gravity below 20. The heavy hydrocarbons may be mobile or immobile at initial reservoir conditions and may have different characteristics depending on the given reservoir. Heavy hydrocarbons should be understood to include what are generally known as heavy oil, extra-heavy oil and bitumen. Based on API gravity, heavy oil has an API gravity between 10 and 20, and extra heavy oil has an API gravity of less than 10. It is additionally noted that the hydrocarbon reservoir may contain low molecular weight hydrocarbon compounds, e.g. toluene at a concentration of 1 mM-2 mM.

In accordance herewith, a reservoir is identified and selected to comprise a region comprising geological hydrocarbon and a microbial culture. The microbial culture, which may be identified by various sampling techniques, should be capable of metabolizing an exogenously supplied low molecular weight oil soluble hydrocarbon compound and electron acceptor, notably by being able to use the low molecular weight oil soluble hydrocarbon compound as an electron donor, and by reducing the electron acceptor. The microbial culture may be more or less homogenously distributed throughout a reservoir. Thus a reservoir may comprise one, two or more regions that comprise microbial cultures suitable for use in accordance with the present disclosure. The geometric dimensions of the regions may vary.

The reservoir may further be identified and selected in accordance with the porosity and/or permeability. The porosity and permeability may be identified by estimation, modeling, sampling or seismic response techniques, in order to identify a target zone for introduction of the chemical compounds in accordance with the present disclosure. Such target zones are selected to have permeabilities that are sufficiently high to facilitate introduction of the chemical compounds, e.g. by injection of a microbial stimulation fluid. Sampling or seismic data may be used to model the reservoir and identify one or more regions suitable for injection, depending on the distribution of initial porosity and permeability, the microbial cultures, and geological characteristics, such as the distribution and size of holes and fractures, type of geological formation, and type of geological hydrocarbon.

In some implementations, the microbial culture in the region of the hydrocarbon reservoir is a microbial culture capable of using the low molecular weight hydrocarbon compound as an electron donor and reducing the electron acceptor, for example, a microbial culture that metabolizes nitrate according to the following chemical reaction (I):

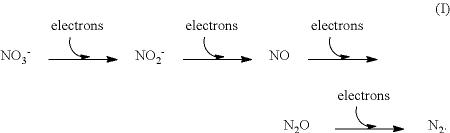

In further implementations, the microbial culture is capable of metabolizing nitrate and performing only one step of the chemical reaction (I), for example:

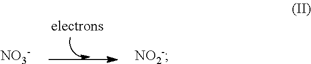

or two steps (i.e. production of NO), or three steps (i.e. production of N₂O).

In further implementations, the microbial culture is capable of metabolizing nitrate and forming ammonium (NH₄⁺) according to the following chemical reaction:

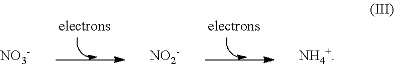

In further implementations, the microbial culture is capable of metabolizing a low molecular weight hydrocarbon compound to form carbon dioxide (CO₂) and water (H₂O).

In further implementations, the microbial culture is capable of metabolizing toluene according to the following reaction (IV):

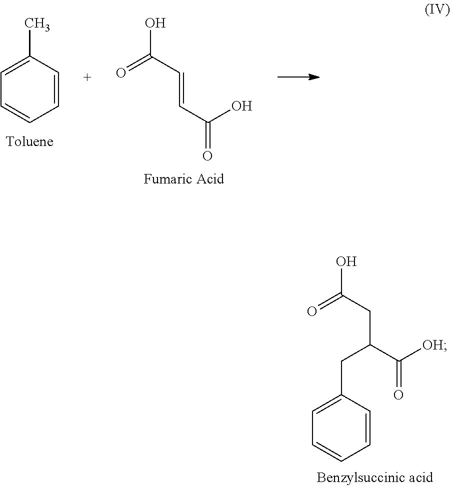

and, optionally, in accordance to the following reaction (V):

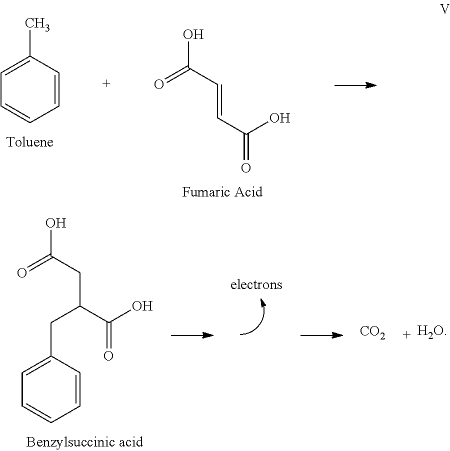

It is noted that the microbial culture may include any microbial culture, including any microbial culture endogenously present in the hydrocarbon reservoir. This includes any indigenous microbial culture. “Indigenous”, as used herein refers to any microbial culture naturally present in a hydrocarbon reservoir. The microbial culture further may include various anaerobic, thermophilic, halophilic or barophilic microbial species, archaea, as well as mixtures including a plurality of phyla, classes genera, or species. The microbial culture further may comprise Bacteria belonging to the phylum Proteobacteria, class Gammaproteobacteria or class Beta proteobacteria, and Bacteria belonging to the phyla Actinobacteria; Bacteroidetes; or Firmicutes, as well as Bacteria, belonging to the genera Thauera; Thermomonas; Truepera; Pseudomonas, including Pseudomonas stutzeri; Variovorax; Propioniovibrio or Diaphorobacter. The microbial culture may also comprise Archaea of the phylum Euryarchaeota, or other phyla.

The process further may include identifying microbial cultures in a reservoir. Accordingly, the process may include the steps of obtaining a sample from the region of a hydrocarbon reservoir, and identifying microbial cultures within the sample. In certain implementations, the process includes identifying a microbial strain capable of reducing an electron acceptor and using a low molecular weight oil soluble hydrocarbon compound as an electron donor.

Accordingly, in some implementations, the present disclosure provides a method comprising:
(a) identifying a microbial culture capable of metabolizing an oil soluble low molecular weight hydrocarbon and an electron acceptor in a hydrocarbon reservoir;
(b) introducing a low molecular weight oil soluble hydrocarbon compound and electron acceptor into the hydrocarbon reservoir wherein at least a portion of the low molecular weight oil soluble hydrocarbon compound and the electron acceptor enters a region of the hydrocarbon reservoir comprising geological hydrocarbon and the microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(c) recovering the geological hydrocarbon from the hydrocarbon reservoir.

The steps of delivering a low molecular weight hydrocarbon compound and electron acceptor may be adjusted based on the identification in step (a).

Microbial cultures capable of catalyzing a reaction involving the reduction of an electron acceptor may be identified by obtaining samples, for example drill cores, and cultivating such cultures and/or analyzing nucleic acid sequences, ribosomal RNAs, for example, or other strain specific characteristics. For example, samples from reservoirs may be obtained to evaluate the presence of microbial strains capable of using an electron acceptor. Such evaluation may involve the incubation of the reservoir sample under anaerobic conditions in the presence of an electron acceptor and a low molecular weight hydrocarbon compound and monitoring the metabolic activity of bacterial strains. The analytical information obtained may be used to optimize the amounts and forms in which the low molecular weight hydrocarbon compound and the electron acceptor are delivered to the geological formation. Thus the amount of electron acceptor and low molecular weight hydrocarbon compound may be selected so that the maximal amount of degradation of the low molecular weight hydrocarbon compound occurs and/or so that a maximal amount of electron acceptor reduction occurs.

In some implementations, the low molecular weight hydrocarbon compound and electron acceptor are injected into a reservoir using a microbial stimulation fluid. A microbial stimulation fluid may be injected in various ways, depending on, for example, the properties of the microbial stimulation fluid and the reservoir characteristics. In one implementation, a microbial stimulation fluid may be delivered by providing the microbial stimulation fluid to a surface wellhead connection where the microbial stimulation fluid may be injected, using a pump for example, in the casing-tubing annulus of the well and/or the tubing string. Upon injection of the microbial stimulation fluid, the low molecular weight hydrocarbon compound and electron acceptor migrate down the casing-tubing annulus or tubing string to distal locations, which if injected in the casing-tubing annulus, may include one or more subsurface injection valves that convey the low molecular weight hydrocarbon compound and electron acceptor to the tubing string. At one or a plurality of distally located apertures in the tubing line, the electron acceptor and low molecular weight hydrocarbon compound effuse from the tubing to enter the reservoir by flow and/or diffusion and disperse through the holes and fractures of the geological formation. The “injection point” may be seen as the point in the reservoir at which the electron acceptor and low molecular weight hydrocarbon compound is released from the injection equipment, e.g. an aperture in a tubing string, and is free to migrate through the reservoir into a region comprising geological hydrocarbon and a microbial culture, and becomes available for metabolism by the microbial culture. The microbial stimulation fluid may be injected at one or more proximate or distant injection points in a reservoir. The “deposition zone” may be seen as the zone in the reservoir at which the low molecular weight hydrocarbon compound and electron acceptor are deposited within the geological formation. In some implementations, at least 50% of the injected hydrocarbon compound and electron acceptor is deposited in the deposition zone, in others at least 60%, at least 70%, at least 80% or at least 90%. Deposition of the low molecular weight hydrocarbon compound may involve dissolving of the low molecular weight hydrocarbon compound into the geological hydrocarbon. The deposition zone may be located in spaced relation from the injection point. The deposition zone may, for example, be a region located 1 or 2 meters away from the injection point, it may be located about 100 to 200 meters away from the injection point, or it may be located as far as 1 to 2 km away from the injection point. The deposition zone may be covering part or all of a reservoir, and one or more deposition zones may form within a reservoir. The deposition zone within the reservoir is reached following dispersal of the electron acceptor and low molecular weight hydrocarbon compound from the injection point, which may be located within the region comprising the geological hydrocarbon and microbial culture, or outside of the region comprising the geological hydrocarbon and microbial culture.

FIGS. 1A, 1B, 1C and 2A, 2B and 2C illustrate exemplary implementations of the present disclosure. Referring now to FIG. 1A, shown therein is a reservoir (22), a surface well (10) and a tubing string (12) through which a microbial stimulation fluid may be injected into the reservoir (22). In the implementation (25) of FIG. 1A, the microbial stimulation fluid (F), after injection at the surface well (10) migrates vertically down the tubing string (12) and enters the reservoir at a single injection point (14) into a region (18) of the reservoir (22) comprising geological hydrocarbon and a microbial culture, and establishing a deposition zone (20). In this implementation (25), the deposition zone (20) is located spaced away from the injection point (14).

In another implementation (50), shown in FIG. 1B, a plurality of injection points (14) is employed. In implementation (50), the injection points (14) are located adjacent to the region (18) comprising the geological hydrocarbon and microbial culture, as well as adjacent to the deposition zone (20) within the reservoir (22). Furthermore it is noted that in this implementation (50) the microbial stimulation fluid (F) enters the reservoir through a horizontally positioned section of the tubing string (12).

In another implementation (100), shown in FIG. 1C, two injection points (14A) and (14B) are both spaced away in the reservoir (22) from two regions (18A) and (18B) comprising geological hydrocarbon and a microbial culture. Two separate deposition zones (20A) and (20B) are formed in region (18A), and a single deposition zone (20C) is formed in region (18B). The implementation of FIG. 1C further illustrates that a portion of the microbial stimulation fluid (F) may not enter region (18A) or (18B), and a deposition zone may partially form inside region (18A) or (18B) and partially outside region (18A) or (18B), as illustrated by deposition zone (20B) and (20C).

FIG. 2 shows implementation (50) and illustrates dispersal of the microbial stimulation fluid and establishment of the deposition zone (20) as a function of time. Shown in FIG. 2A is implementation (50), at the time of initiation of injection of the microbial stimulation fluid (F) from various injection points (14) in the tubing string (12) into the region (18) of the hydrocarbon reservoir comprising geological hydrocarbon and a microbial culture. As shown in FIG. 2B and FIG. 2C, representing an earlier and a later time point, respectively, of the same implementation (50) following injection of the microbial stimulation fluid (F), the front (21) of the deposition zone (20) moves further away in space from the injection points (14), and the deposition zone (20) expands in size.

In order to achieve dispersal of the low molecular weight hydrocarbon compound and electron acceptor to more or less remote locations away from the injection point, the microbial stimulation fluid may be injected under pressure. The pressures used may be a function of the residual pressure in the geological formation, which must be overcome. Pressures may be kept below fracturing pressure, unless it is intended to combine the process with fracturing. Injection pressures at the wellhead may vary from about 10 psi to about 10,000 psi. The pressure at the wellhead may be about 100 psi. The pressure may also be varied and it should be understood that by increasing the pressure used to inject the microbial stimulation fluid comprising the electron acceptor and the low molecular weight hydrocarbon compound, locations more remotely from the injection point may be reached.

In some implementations, a microbial stimulation fluid is injected into the region of the reservoir at a temperature in order to heat the hydrocarbon reservoir to a desired temperature. The fluid temperature should be high enough to heat the region to the desired temperature, yet not so high that the fluid detrimentally affects microbial activity. In general, the region is heated to a temperature that favors metabolic activity of the microbial culture. The region may also be heated by a source other than the microbial stimulation fluid before or during fluid injection. Such heating may be achieved by using a separate heating fluid or steam (e.g. as used in steam assisted gravity drainage (SAGD) processes for oil recovery) or a downhole heating device. Heating of the region may also be achieved due to its location adjacent to a thermal hydrocarbon recovery operation from which heat is transmitted to the region. The region may also be heated by a combination of the above or other heating methods. It should be understood that the temperature may be adjusted to be between 1° C. and 120° C., and optionally between 30° C. and 90° C.; between 30° C. and 60° C. or between 45° C. and 55° C. At sufficiently high temperatures the viscosity of the geological hydrocarbon may be reduced. Above 45° C., for example, the viscosity or bitumen, is expected to be decreased to molasses-like values.

The amount, temperature, flow rate, pressure and injection cycle of the microbial stimulation fluid that is used may vary. The microbial stimulation fluid may be injected continuously, or intermittently.

In some implementations, a first microbial stimulation fluid comprising a low molecular weight hydrocarbon compound may be prepared, and a second microbial stimulation fluid comprising an electron acceptor may be prepared. The first and second microbial stimulation fluid may be injected simultaneously or separately, either by injecting the first microbial stimulation fluid first or by injecting the second microbial stimulation fluid first. When a first and second microbial stimulation fluid are injected separately, the period of time between the two injections may vary, and may, for example, be approximately 1 hour; approximately 1 day; approximately 10 days or approximately 100 days. Thus, in certain implementations, a first microbial stimulation fluid comprising a low molecular weight hydrocarbon compound may be injected, and deposited in the reservoir, and at a later point in time, a second microbial stimulation fluid comprising an electron acceptor may be injected into the reservoir. Furthermore, in certain implementations, a plurality of injections of microbial stimulation fluids may be performed of either the first microbial stimulation fluid, or the second microbial stimulation fluid or the first and second microbial stimulation fluid, alternating between the two fluids, either at the same injection point or at different injection points.

In other implementations, a microbial stimulation fluid is prepared comprising both an electron acceptor and a low molecular weight hydrocarbon compound and such microbial stimulation fluid is injected into the hydrocarbon reservoir.

Upon delivery and deposition of the low molecular weight hydrocarbon and electron acceptor to the reservoir, the metabolic activity of a microbial culture is stimulated. Such stimulation leads to the promotion of flow of geological hydrocarbon in the reservoir, e.g. the promotion of flow in the macro-fractures, milli-fractures, or micro-fractures of the geological formation.

The metabolic activity of the microbial culture may lead to the production of biomass plugging macro-fractures, milli-fractures or micro-fractures in the geological formation. Upon injection of further fluid into the reservoir, the migration trajectory of the fluid through the reservoir may alter, thus leading to the promotion of flow of geological hydrocarbon to alternate areas of the reservoir.

The metabolic activity of the microbial culture may lead to the production of enzymes, e.g. enzymes capable of degrading geological carbon. The degradation products may have superior viscosity characteristics and thus this may lead to promotion of flow of the geological hydrocarbon. Thus for instance, the production of microbial enzymes may lead to the degradation of heavy oil to form lighter oil.

The metabolic activity of the microbial culture may lead to the production of surface active compounds, decreasing the interfacial tension between oil and the surrounding geological formation and promoting the flow of geological hydrocarbon in the reservoir.

The metabolic activity of the microbial culture may lead to the production of gas, N₂, and/or CO₂ gas, for example, thus locally increasing the pressure, facilitating release of the geological hydrocarbon from the surrounding geological formation, and promoting the flow of geological hydrocarbon in the reservoir.

The metabolic activity of the microbial culture may lead to the production of an acidic agent, for example an organic acid, such as acetic acid, dissolving portions of the geological formation, increasing the porosity and/or permeability of the geological formation and promoting the flow of geological hydrocarbon in the reservoir.

In accordance with the present disclosure hydrocarbon is recovered from the reservoir treated using the techniques disclosed herein. In some implementations, a microbial stimulation fluid is injected continuously and geological hydrocarbon recovery may commence immediately upon delivery of a microbial stimulation fluid. In some implementations, recovery of geological hydrocarbon may be carried out simultaneously with the injection of a microbial stimulation fluid. Continuous injection of microbial stimulation fluid or another fluid, e.g. water, and simultaneous recovery of hydrocarbon is feasible in accordance with the present disclosure, since the low molecular weight hydrocarbon compound is soluble in geological hydrocarbon. Thus as microbial stimulation fluid disperses in the reservoir, low molecular weight hydrocarbon compound dissolves into geological hydrocarbon and is in situ deposited within the reservoir and made available for contact with microbial cultures. Electron acceptor, typically present in substantially higher concentrations than the low molecular weight hydrocarbon compound, is also in situ deposited in the reservoir and made available for contact with microbial cultures.

In some implementations, prior to injection of the microbial stimulation fluid, water or another fluid is delivered to the hydrocarbon reservoir. In some implementations, a microbial stimulation fluid may be co-injected with water or another fluid used to pressurize a well. In some implementations, water or other fluids may continuously be delivered to the hydrocarbon reservoir, and the microbial stimulation fluid may be intermittently delivered, for example by intermittent amendment of the water of or other fluids with a microbial stimulation fluid.

In other implementations, after injection of the microbial stimulation fluid, there may be a soaking period that is provided prior to commencing hydrocarbon recovery. For example hydrocarbon recovery may be delayed until at least 2 days after injection of the microbial stimulation fluid. In other implementations, hydrocarbon recovery is not initiated until at least 10 days; 20 days; 30 days; 60 days; 90 days; 120, days; 180 days or 360 days following the delivery of the microbial stimulation fluid to the hydrocarbon reservoir.

Extraction methodologies used for the recovery of hydrocarbons will be well known to persons of skill in the art of hydrocarbon recovery, and include the use of drilling wells, including on shore and off shore wells, exploration wells, production wells, condensate wells and the like. Wells and other recovery equipment may be implemented and operated using any conventional operational methodology familiar to operators of such equipment. It will further be clear to those of skill in the art that once recovered the hydrocarbon may be used as a feedstock for upgrading, refining and energy production.

### EXAMPLES AND EXPERIMENTATION

### Example 1

### Hydrocarbon- and Nitrate-Mediated Microbially Enhanced Oil Recovery in Low Pressure Bioreactors

Experiments were conducted with heavy oil from the Medicine Hat Glauconitic C (MHGC) field near Medicine Hat, Alberta, Canada. The MHGC field is a shallow (850 m), low-temperature (30° C.) field from which heavy oil with an American Petroleum Institute (API) gravity of 12-18° and a viscosity of 3400 cP at 20° C. is produced by water injection. Produced water from producing well 5 (5PW) was used as a source of heterotrophic nitrate reducing bacteria (hNRB). These were grown in 120-mL serum bottles, containing 47.5 mL of an aqueous phase and 1 ml of an oil phase. The aqueous phase consisted of sterile anaerobic CSBK medium, containing g/L: 1.5 NaCl, 0.05 KH₂PO₄, 0.32 NH₄Cl, 0.21 CaCl₂.2H₂O, 0.54 g MgCl₂.5H₂O and 0.1 KCl; 30 mM NaHCO₃, nutrients including trace elements and either 0 or 80 mM NaNO₃. The oil phase was 1 ml of MHGC oil or 1 ml of MHGC oil with additional electron donors (either 60 μl of toluene or 30 μl toluene and 30 heptane). The headspace was filled with anaerobic gas, 90% (v/v) N₂ and 10% CO₂. The bottles were closed with butyl rubber stoppers and were inoculated with 2.5 ml of 5 PW and incubated at 30° C. In serum bottles with additional electron donor and nitrate up to 59% of the added nitrate was reduced under these conditions. In the absence of additional electron donor little nitrate reduction was observed. These cultures were used to inoculate oil-containing bioreactors. Sequencing of 16S rRNA genes, amplified with the polymerase chain reaction was used to determine the microbial community composition of these cultures. The results for a culture containing additional toluene in the oil phase and 80 mM nitrate indicated that this culture is dominated by Thauera, as indicated in the table (TABLE 1) below.

TABLE 1

| Predominant taxon | |
|---|---|
| Kingdom; phylum; class; order; family; genus | % |
| Bacteria; Proteobacteria; Betaproteobacteria; Rhodocyclales; | 95.237 |
| Rhodocyclaceae; Thauera | |
| Bacteria; Proteobacteria; Gammaproteobacteria; | 0.162 |
| Xanthomonadales; Xanthomonadaceae; Thermomonas | |
| Bacteria; Deinococcus-Thermus; Deinococci; Deinococcales; | 1.491 |
| Trueperaceae; Truepera | |
| Bacteria; Proteobacteria; Gammaproteobacteria; | 1.458 |
| Pseudomonadales; Pseudomonadaceae; Pseudomonas | |
| Bacteria; Proteobacteria; Betaproteobacteria; Burkholderiales; | 0.065 |
| Comamonadaceae; Variovorax | |
| Bacteria; Proteobacteria; Betaproteobacteria; Burkholderiales; | 0.065 |
| Comamonadaceae; Diaphorobacter | |
| Bacteria; Proteobacteria; Betaproteobacteria; Burkholderiales; | 0.583 |
| Alcaligenaceae; Castellaniella | |
| Bacteria; Proteobacteria; Betaproteobacteria; Rhodocyclales; | 0.097 |
| Rhodocyclaceae; Propionivibrio | |

For experiments on enhanced oil recovery at low pressure 30 mL plastic syringe sand-pack bioreactors with a pore volume (PV) of 15 ml were injected with CSBK medium under upward flow conditions. The CSBK medium was then replaced with heavy oil or with heavy oil with 11.4 mM of toluene or with heavy oil with 6 mM of heptane and 6 mM toluene. Oil contained in the bioreactors was eluted at a rate of 15 ml/day with anoxic CSBK using a peristaltic pump. The oil content of the produced oil-water mixture was determined daily by adding dichloromethane and measuring with a spectrophotometer. Following injection of 15 PV of CSBK a total of 0.5 PV of oil was produced with approximately 0.45 PV of oil remaining in the bioreactors. We refer to this as stage 1. In stage 2 bioreactors were injected with 0.5 PV of an appropriate microbial culture or with an appropriate microbial culture with 80 mM nitrate. Bioreactors were then incubated without flow for 14 days. Following incubation, flow of CSBK medium at 1 PV/day was resumed in stage 3. Oil and water production were measured throughout the procedure. Concentrations of nitrate in the aqueous phase and of toluene in the oil phase were measured by HPLC and GC-MS, respectively.

The oil production from bioreactor_I6 containing microbial culture and 80 mM nitrate and oil with 11.4 mM of added toluene is compared with the oil production from bioreactor_I1 containing microbial culture and no nitrate and oil with no added toluene in FIG. 3A. Following stage 2 incubation an additional 24% of residual oil in place (ROIP) was produced in bioreactor_I6, whereas bioreactor_I1 had no additional oil production (FIG. 3A). Repeating the incubation as in stage 2 and subsequent injection of CSBK medium gave additional oil production as shown for stages 4 and 5 (FIG. 3A), indicating that cycles of incubation and water flooding to enhance oil recovery can be done multiple times.

The oil production from bioreactor_III4 containing microbial culture and 80 mM nitrate and oil with no added toluene is compared with the oil production from bioreactor_III1 containing microbial culture and no nitrate and oil with no added toluene in FIG. 3B. Following stage 2 incubation an additional 2.4% of residual oil in place (ROIP) was produced in bioreactor_III4, whereas bioreactor_III1 had no additional oil production (FIG. 3B).

The oil production from bioreactor_IV6 containing microbial culture and 80 mM nitrate and oil with 6 mM heptane and 6 mM toluene is compared with the oil production from bioreactor_IV2 containing microbial culture and no nitrate and oil with 6 mM heptane and 6 mM toluene in FIG. 3C. Following stage 2 incubation and stage 3 elution an additional 24% of ROIP was produced in bioreactor_IV6, whereas an additional 6.6% of ROIP was produced in bioreactor_IV2. Hence, a mixture of heptane and toluene can also be used for production of ROIP.

The results in FIG. 3A, FIG. 3B and FIG. 3C indicate that high concentrations of both nitrate in the aqueous phase and of a low molecular weight hydrocarbon in the oil phase (either toluene or toluene and heptane) must be present for significant production of additional oil as in bioreactor_I6 and bioreactor_IV6.

Measurements of the nitrate concentration in the bioreactor effluents following stage 2 are presented in FIG. 4. Effluents of bioreactor_III4 had a maximum of 70 mM nitrate (FIG. 4A), indicating that little of the 80 mM of nitrate added was reduced. Effluents of bioreactor_III1 had 0 mM nitrate in agreement with the fact that no nitrate was added. Effluents of bioreactor_IV6 had only 3.5 mM nitrate. This indicated that metabolic activity of the hNRB reduced most of the 80 mM nitrate to N₂, while oxidizing toluene and/or heptane to CO₂. Effluents of bioreactor_IV2 had 0 mM nitrate in agreement with the fact that no nitrate was added (FIG. 4B).

### Example 2

### Hydrocarbon- and Nitrate-Mediated Microbially Enhanced Oil Recovery in High Pressure Bioreactors

Up-flow stainless steel bioreactors were packed with sand and flooded with CSBK medium at high pressure (400 psi=27.2 atm) using a TELEDYNE Isco D Syringe pump connected to a backpressure regulator. These bioreactors had a pore volume PV=35 ml. Bioreactors were then flooded with 1 PV of heavy oil or with 1 PV of heavy oil with 11.4 mM of toluene. Both bioreactors were then flooded with CSBK to 0.45 PV of residual oil in stage 1. The oil content of the produced oil-water mixture was determined daily by adding dichloromethane and measuring with a spectrophotometer. Following injection of 15 PV of CSBK a total of 0.5 PV of oil was produced with approximately 0.45 PV of oil remaining in the bioreactors in stage 1. In stage 2 bioreactors were injected with 0.5 PV of an appropriate microbial culture or with an appropriate microbial culture with 80 mM nitrate. Bioreactors were then incubated without flow for 14 days. Following incubation, flow of CSBK medium at 1 PV/day was resumed in stage 3. Oil and water production were measured throughout the procedure. Concentrations of nitrate in the aqueous phase and of toluene in the oil phase were measured by HPLC and GC-MS, respectively.

The oil production from bioreactor_VIIIB containing microbial culture and 80 mM nitrate and oil with 11.4 mM of added toluene is compared with the oil production from bioreactor_VIIIA containing microbial culture and no nitrate and oil with 11.4 mM of added toluene. Following stage 2 incubation and stage 3 elution an additional 19.7% of ROIP was produced in bioreactor_VIIIB, whereas an additional 4.5% of ROIP was produced in bioreactor_VIIIA (FIG. 5A). Monitoring the toluene concentration in the oil phase of the bioreactor effluents indicated that this dropped to zero in bioreactor_VIIIB, whereas it remained at a high concentration of 8 mM in bioreactor_VIIIA (FIG. 5B). Effluents of bioreactor_VIIIB also had a low nitrate concentration (results not shown). These results indicate that in high pressure bioreactor_VIIIB, the production of additional oil was caused by microbial activity oxidizing toluene, while reducing nitrate. This activity was not observed in bioreactor_VIIIA, because nitrate was absent. As a result bioreactor_VIIIA produced much less ROIP.

### Example 3

### Increasing Low Molecular Weight Hydrocarbon Content of ROIP by Injection of an Aqueous Solution into a Low Pressure Bioreactor

In field applications of the proposed MEOR technology, the content of low molecular weight hydrocarbon in the oil phase must be increased by injection, e.g. of a solution of the low molecular weight hydrocarbon in water or microbial stimulation fluid. In order to increase the toluene concentration of the ROIP, low pressure bioreactors, as in example 1, containing 0.45 PV of residual MHGC oil were injected with 2 PV of a solution of 3 mM toluene in water at a flow rate of either 1.0 PV/day or 0.5 PV/day. Following this, the bioreactors were sacrificed and the toluene concentration in oil extracted from 5 fractions from the bottom to the top were measured. In the bioreactor injected with 0.5 PV/day these were 9.3, 3.6, 2.0, 1.9 and 3.7 mM, respectively, whereas in the bioreactor injected with 1.0 PV/day these were 4.4, 1.9, 2.4, 1.9 and 2.8 mM, respectively. These values were considerably higher than those typically found in MHGC oil (1.5 mM), indicating that the toluene content of ROIP can be increased by injection of toluene dissolved in the injected aqueous phase.

### Example 4

### Microbially Enhanced Oil Recovery by Injection of an Aqueous Solution of Low Molecular Weight Hydrocarbon in a High Pressure Bioreactor

Up-flow stainless steel bioreactor_XA and bioreactor_XB were packed with sand and flooded with CSBK medium at high pressure as in example 2. These bioreactors had a pore volume PV=35 ml. Bioreactor_XA was then flooded with 1 PV of heavy oil, whereas bioreactor_XB was then flooded with 1 PV of heavy oil with 11.4 mM of toluene. Both bioreactors were then flooded with 15 PV of CSBK to 0.45 PV of residual oil. Bioreactor_XA was then flooded with 10 PV of a solution of CSBK with 3 mM toluene, whereas bioreactor XB, which already had additional toluene in the oil, was flooded with 10 PV of CSBK medium. The flow rate was 1 PV/day throughout. In stage 2, bioreactors were injected with 0.5 PV of an appropriate microbial culture with 80 mM nitrate. Bioreactors were then incubated without flow for 14 days. Following incubation, flow of CSBK medium at 1 PV/day was resumed in stage 3. Bioreactor_XA, which gained additional toluene by separate injection in the reactor, produced an additional 36.5% of ROIP. Bioreactor_XB, which was flooded with oil spiked with additional toluene, produced an additional 12% of ROIP (FIG. 6). Effluents of bioreactor_XA and bioreactor_XB had a low nitrate concentration (results not shown). These results indicate that injection of a solution of low molecular weight hydrocarbon in water or microbial stimulation fluid, as would be required in field applications, can produce significant additional ROIP. CLAIMS

1. A method of recovering geological hydrocarbon from a hydrocarbon reservoir, the method comprising:
(a) introducing a low molecular weight oil soluble hydrocarbon compound and an electron acceptor into a hydrocarbon reservoir wherein at least a portion of the low molecular weight oil soluble hydrocarbon compound and the electron acceptor enters a region of the hydrocarbon reservoir comprising geological hydrocarbon and a microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(b) recovering the geological hydrocarbon from the hydrocarbon reservoir.

2. The method according to claim 1 wherein the method involves injecting a microbial stimulation fluid comprising the low molecular weight oil soluble hydrocarbon compound and electron acceptor into the hydrocarbon reservoir.

3. The method according to claim 2 wherein the microbial stimulation fluid is injected at an injection point in the hydrocarbon reservoir and the low molecular weight oil soluble hydrocarbon and electron acceptor are deposited in a deposition zone in the reservoir wherein the injection point is adjacent to the deposition zone.

4. The method according to claim 2 wherein the microbial stimulation fluid is injected at an injection point in the hydrocarbon reservoir and the low molecular weight oil soluble hydrocarbon and electron acceptor are deposited in a deposition zone in the reservoir wherein the injection point is spaced away from the deposition zone.

5. The method according to claim 1 wherein the region is preheated to a temperature from about 30° C. to about 90° C.

6. The method according to claim 2 wherein the microbial stimulation fluid is preheated to achieve a temperature in the region of from about 30° C. to about 90° C.

7. The method according to claim 1 wherein the method involves injecting a first microbial stimulation fluid comprising the low molecular weight oil soluble hydrocarbon compound and a second microbial stimulation fluid comprising electron acceptor into the hydrocarbon reservoir.

8. The method according to claim 1 wherein the method involves soaking the region for at least 2 days prior to commencing hydrocarbon recovery.

9. The method according to claim 2 wherein the method involves co-injecting the microbial stimulation fluid in a well with another fluid which is injected in the reservoir to pressurize the reservoir.

10. The method according to claim 1 wherein the reservoir comprises heavy oil.

11. The method according to claim 1 wherein the electron acceptor is a reducible nitrogen containing compound.

12. The method according to claims 1 wherein the electron acceptor is selected from the group of compounds consisting of nitrate, nitrite, nitrous oxide, nitric oxide, perchlorate, chlorate, chlorite, hypochlorite, ferric iron and oxygen.

13. The method according to claim 1 wherein the microbial culture comprises bacterial species belonging to the phylum Proteobacteria, Actinobacteria; Bacteroidetes, Euryarchaeota or Firmicutes.

14. The method according to claim 1 further comprising identifying microbial cultures in the reservoir.

15. The method according to claim 2 wherein the low molecular weight oil soluble hydrocarbon is dissolved in the microbial stimulation fluid to a concentration of approximately its solubility limit.

16. The method according to claim 1 wherein hydrocarbon recovery is initiated immediately upon introduction of the low molecular weight hydrocarbon.

17. The method according to claim 2 wherein hydrocarbon recovery from the reservoir is conducted simultaneously with injection of the microbial stimulation fluid.

18. The method according to claim 1 wherein the microbial culture is an indigenous microbial culture.

19. The method according to claim 2 wherein the microbial stimulation fluid is injected continuously, and the geological hydrocarbon recovery is conducted simultaneously with injection of the microbial stimulation fluid.

20. A method comprising:
(a) identifying a microbial culture capable of metabolizing an oil soluble low molecular weight hydrocarbon and an electron acceptor in a hydrocarbon reservoir;
(b) introducing a low molecular weight oil soluble hydrocarbon compound and electron acceptor into the hydrocarbon reservoir wherein at least a portion of the low molecular weight oil soluble hydrocarbon compound and the electron acceptor enters a region of the hydrocarbon reservoir comprising geological hydrocarbon and the microbial culture, such that the oil soluble low molecular weight hydrocarbon compound and electron acceptor stimulate the metabolic activity of the microbial culture, and the promotion of flow of the geological hydrocarbon in the hydrocarbon reservoir; and
(c) recovering the geological hydrocarbon from the hydrocarbon reservoir.
